(19) United States
(12) Patent Application Publication
(10) Pub. No.: US 2007/0018813 A1
(43) Pub. Date: Jan. 25, 2007

(54) Electronic identification tag

(76) Inventor: Richard C. Liggitt, Shady Canyon, CA (US)

Correspondence Address: WALTER T. KIM, SUITE 1300, 2030 MAIN STREET, IRVINE, CA, 92614, US

(21) Appl. No.: 11/188,200

(22) Filed: Jul. 22, 2005

(51) Int. Cl. G08B 1/08; H04Q 7/00

(52) U.S. Cl. 340/539.32

(57) ABSTRACT

An apparatus is provided to facilitate identification and/or locating of an object. The apparatus includes a receiver to receive wireless signals and an indicator coupled to the receiver to provide an indication of valid activation signal detection. The apparatus further includes a power controller coupled to the receiver and a power source to prevent power from being supplied to the receiver in a first mode and enable power to be supplied in a second mode. The power controller is configured to automatically switch from the first mode to the second mode in response to reception of at least one defined range of signal frequency.

### BACKGROUND OF THE INVENTION

1. Field of the Invention

The present invention generally relates to electronic receiver devices, and more particularly to electronic tags for identifying and/or locating the tagged objects.

2. Description of the Related Art

Various electronic tags have been proposed to assist users identify and/or locate tagged objects. Typically, transmitter unit is used to output an activation signal which a corresponding electronic tag is configured to respond. Upon receiving the activation signal from the transmitter unit, the electronic tag activates one of its alerting features to help the user to locate and/or identify a particular object to which the tag is attached. However, there are a number of disadvantages associated with existing electronic identification tag systems. For example, one of the problems associated with conventional electronic tags is that the wireless receiver contained therein typically remains turned on requiring continuous power usage from its limited power source. Accordingly, there is need for electrically powered devices having wireless receiver contained therein that can better conserve their limited power source.

### BRIEF SUMMARY OF EMBODIMENTS THE INVENTION

Described herein are various embodiments of an electronic powered device which includes a power controller to reduce power consumption. In one embodiment, the power controller is coupled to a wireless receiver to prevent power from being supplied to the receiver in a first mode and enable power to be supplied in a second mode. The power controller is configured to automatically switch from the first mode to the second mode in response to reception of at least one defined range of signal frequency.

According to an embodiment, the electronic device includes electromagnetic energy detection (EED) circuit that is responsive to at least one defined range of signal frequency. When the defined range of signal frequency is detected, a signal is outputted by the EED circuit which is used to turn on a switch to enable power supplied to the electrically powered components within the receiver unit. In one embodiment the EED circuit is a passive circuit that does not require power supplied from a power source but converts the electromagnetic energy of the signal transmitted by a transmitter unit into a current. In one embodiment, the passive circuit is an inductor-capacitor “tank” circuit responsive to a certain range of signal frequency. In another embodiment, the passive circuit is a tuned circuit which is tuned to respond to a certain range of signal frequency.

According to an embodiment, an identification tag is described for facilitating identification and/or locating of an object. The identification tag includes a receiver to receive wireless signals and an indicator coupled to the receiver to provide an indication of valid activation signal detection. The tag further includes a power controller coupled to the receiver and a power source to reduce power consumption when the receiver is not being used. In one embodiment, this may be accomplished by activating the receiver and/or other components within the identification tag only when certain range of signal frequency is detected.

According to an embodiment, a method is provided for conserving electrical power at an electrically powered device having a wireless receiver contained therein. The method includes switching from a first mode in which power is prevented from being supplied to a wireless receiver component to a second mode in which power is allowed be supplied to the receiver component. In one embodiment, this switching occurs automatically upon detection of at least one defined range of signal frequency. The method may further include powering down the receiver unit if the at least one defined range signal frequency has not been detected within a predetermined time period.

According to an embodiment, a luggage tag is provided to help users locate their luggage at various locations such as, for example, at airport carousel. The luggage tag may include a power source, a receiver to receive wireless signals, a processor coupled to the receiver, the signal processor to recognize at least one defined signal code transmitted by a remote transmitter unit and a user alerting element coupled to the processor to provide an indication of receiving of the defined signal code. The luggage tag further includes a housing having an attachment mechanism to facilitate removable connection to a luggage. The user alerting element may include at least one of a visual device 126 (e.g., light emitting diodes, visual display), an audio producing device 128 (e.g., an audible tone generator, speech message generator) and a vibration device (e.g., a vibration transducer). The processor included within the luggage tag may be capable of learning to recognize at least one coded signal transmitted by a remote transmitter unit, such as a vehicle remote transmitter unit to transmit RF signals to operate at least one remote control function of a vehicle, such as locking and unlocking vehicle doors, unlocking the trunk and/or activate a panic alarm. The luggage tag may further includes a passive electromagnetic energy detection circuit which is used to automatically enable power to be supplied to the receiver in response to reception of at least one range of frequency of signal.

### BRIEF DESCRIPTION OF THE DRAWINGS

Embodiments of the invention are illustrated by way of example and not by way of limitation in the figures of the accompanying drawings in which like references indicate similar elements. It should be noted that the references to “an embodiment” or “one embodiment” of this disclosure are not necessarily to the same embodiment, and such references mean at least one.

FIG. 1 shows a block diagram of a system to facilitate identification and/or locating of an object with an identification tag attached thereto according to one embodiment of the present invention.

FIG. 2 shows a flowchart diagram of a process for facilitating identification and/or locating of an object according to an embodiment of the present invention.

FIG. 3 shows a diagrammatic perspective view of a luggage tag according to one embodiment of the present invention.

### DETAILED DESCRIPTION OF THE INVENTION

In the following description, specific details are set forth in order to provide a thorough understanding of various embodiments of the present invention. However, it will be apparent to one skilled in the art that embodiments of the present invention may be practiced without these specific details. In other instances, well-known components and techniques have not been shown in detail in order to avoid obscuring embodiments of the present invention. It should be noted that, as used in the description herein and the claims, the meaning of “in” includes “in” and “on”.

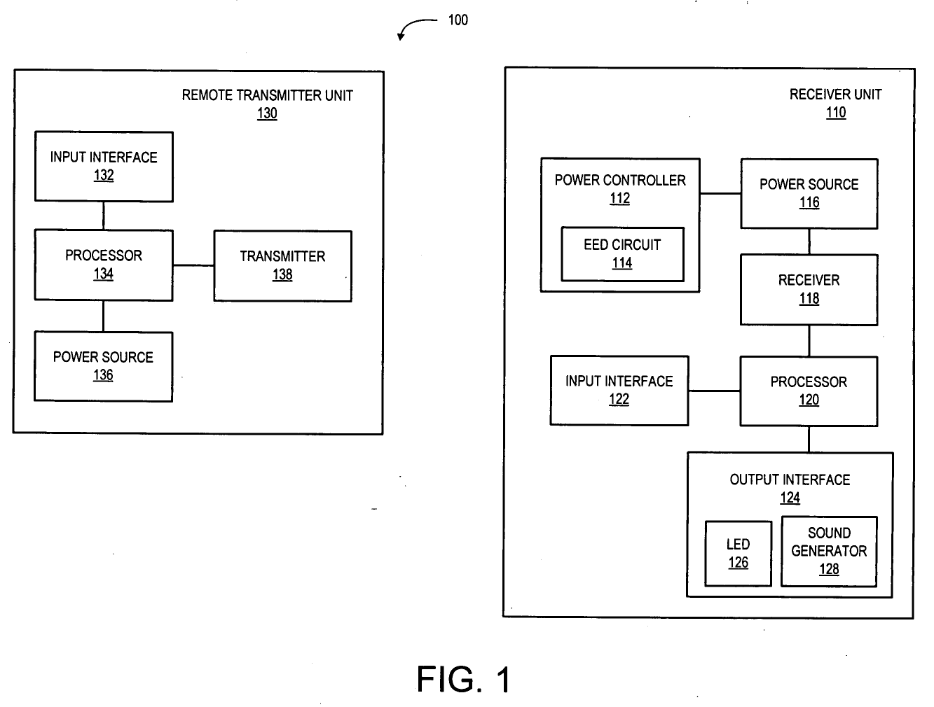

FIG. 1 shows a system 100 for facilitating identification and/or locating of an object according to one embodiment of the present invention. The system 100 includes a remote transmitter unit 130 and a receiver unit 110 to receive wireless signals transmitted by the transmitter unit 130. In one embodiment, the transmitter unit 130 emits an activation signal to which the receiver unit 110 is responsive. Upon receiving the activation signal from the transmitter unit 130, the receiver unit activates one of its alerting features to help the user to locate and/or identify a particular object to which the receiving unit 110 is attached.

The remote transmitter unit 130 may be any suitable wireless transmitter that can output wireless signals such as radio frequency (RF) signals. In the illustrated embodiment, the transmitter unit 130 includes a transmitter 138 coupled to a processor 134 for transmitting coded wireless signals. The processor 134 may be coupled to input interface 130 such as manually actuated switches to allow a user to interact with the processor. When a user presses one of the manually actuated switches, the transmitter unit 130 will emit an activation signal. In one embodiment, the transmitter unit 130 is a vehicle remote transmitter unit to transmit RF signals to operate at least one remote control function of a vehicle, such as locking and unlocking vehicle doors, unlocking the trunk and/or activate a panic alarm. In this case, the receiver unit may be programmed to recognize one of the coded signals emitted by the vehicle remote transmitter unit.

The receiver unit 110 includes a receiver 118 for receiving transmission of wireless signals, a processor 120 coupled to the receiver, and an output interface 124 coupled to the processor. The output interface 124 may include one or more user alerting elements, such as a visual device 126 (e.g., light emitting diodes, visual display), an audio producing device 128 (e.g., an audible tone generator, speech message generator) and a vibration device (e.g., a vibration transducer). Also included in the receiver unit 110 is a power source 116 such as a battery to power the components within the receiver unit. The power source 116 is coupled to a power controller 112 to reduce power consumption when the receiver unit 110 is not being used.

The processor 120 is used to process the signal received by the receiver 118, for example, by decoding the received signal, to determine if the received signal is a valid activation signal. If the received code is a valid activation signal as determined by the processor 120, it will generate a signal operative to activate one of the user alerting elements. Accordingly, each time the receiver unit 110 receives a valid activation signal from the remote transmitter unit 130, the receiver unit 110 will activate an indicator feature to provide audible indication and/or visual indication to facilitate identification and/or location of the object tagged with the receiver unit.

As indicated above, one of the problems associated with conventional identification tags is that the wireless receiver contained therein is typically remains turned on requiring continuous power from its limited power source. In one embodiment, the power is conserved by normally disabling power supplied to the receiver 118 (and optionally disabling power supplied to remainder of electrically powered components) in the receiver unit 110 and automatically enabling power supplied to the receiver 118 (and optionally disabling power supplied to remainder of electrically powered components) when a certain range of signal frequency is detected. In one embodiment, switching circuitry is used to control power supplied to the electrically powered components within the receiver unit 110. The switching circuitry includes electromagnetic energy detection (EED) circuit that is responsive to at least one defined range of signal frequency. When the defined range of signal frequency is detected, a signal is outputted by the EED circuit 114 which is used to enable power supplied to the electronic powered components within the receiver unit. In one embodiment the EED circuit 114 is a passive circuit that does not require power supplied from a power source but converts the electromagnetic energy of the signal transmitted by a transmitter unit into a current.

In one embodiment, the EED circuit 114 comprises inductor-capacitor “tank” circuit. The receiver unit 110 may include multiple tank circuits which are turned to multiple ranges of frequencies. The tank circuit 114 may absorb the electromagnetic radiation energy and convert the energy into a current that may be used to switch on the receiver unit. In another embodiment, the EED circuit 114 is tuned circuit which is tuned to respond to a certain range of frequency of signals.

The power controller 112 may be configured to automatically power down the receiver and/or the remainder of the components after a certain predetermined period of non-use. Accordingly, in one embodiment, if a defined range of signal frequency is not received by the passive circuit within a certain time period, the power controller will generate a signal to turn off power supplied to the receiver 118 (and optionally disabling power supplied to remainder of electrically powered components) within in the receiver unit 110.

The remote transmitter unit 110 may have its own unique digital codes initially programmed therein. In one embodiment, the processor 120 included in the receiver unit 110 is programmable and is capability of learning to recognize one or more digital codes transmitted by the remote transmitter unit 130. For example, the receiver unit 110 may be programmed to recognize digital codes transmitted by a vehicle remote transmitter used to turn on and off a vehicle security system or provide other remote control features for the vehicle.

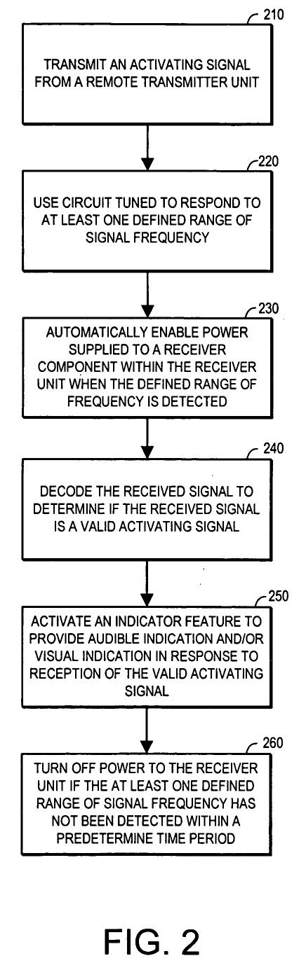

Referring now to FIG. 2, a flowchart is shown of a process for facilitating identification and/or locating of an object according to an embodiment of the present invention. In block 210, when a user desires to locate or identify a tagged object, the user may activate the receiver unit by using the remote transmitter unit to transmit an activating signal. The wireless signal emitted by the remote transmitter unit has a certain range of signal frequency. In block 220, the electromagnetic energy detection (EED) circuit (e.g., tank circuit, tuned circuit) contained within the receiver unit is responsive to the range of signal frequency transmitted by the transmitter unit. In one embodiment, the EED circuit is used to absorb the electromagnetic radiation energy and convert the energy into an electrical current that can be used to switch on the components contained in the receiver unit. In block 230, when the EED circuit detects presence of a defined range of signal frequency, the power controller in the receiver unit is used to automatically enable power supplied to the receiver and the remainder of the components. More specifically, the power controller is used to switch between a disabled mode in which the receiver unit remains powered off and an enabled mode in which the receiver unit is powered on upon detection of the defined range of signal frequency. In block 240, the processor contained within the receiver unit is used to decode the signal from the transmitter unit to determine if it is a valid activation signal. In block 250, upon detection of a valid activation signal, the receiver unit will activate one of its user alerting elements to provide audible indication and/or visual indication so that the user can conveniently locate and/or identify the tagged object. In block 260, the power controller in the receiver unit may be configured to disable power supplied the electrically powered components within the receiver unit if the at least one range signal frequency has not been detected within a predetermined time period.

In one embodiment, the receiver unit is embedded within an identification tag to help a user to identify and/or locate an object with the attached tag. The identification tag may include an attachment mechanism to enable attachment to various objects such as electronic devices or other personal objects.

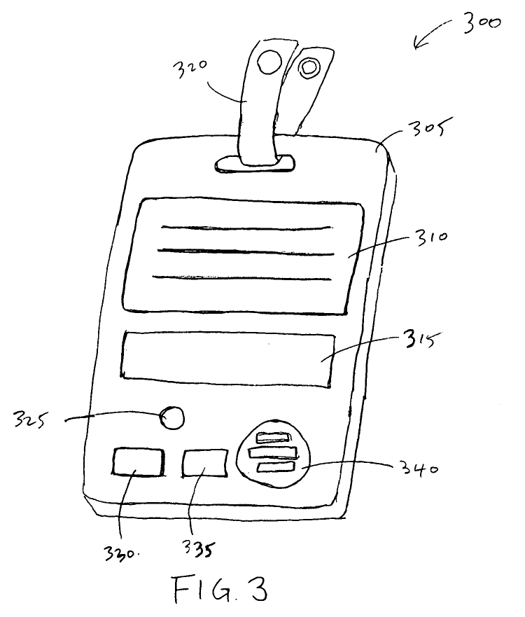

When luggage arrives at airport carousel, it is often difficult for the user to readily identify it. This particularly true when there are many similar luggage unloaded at the same time and place. Conventional luggage tags include the name and information associated with the owner of the luggage. However, conventional luggage tags are typically small in size and the information provided on the tag can only be read at close proximity. Thus, to help users identify their luggage at airport carousel and make it difficult for someone else to accidentally take your bag, in one embodiment, the receiver unit described herein is incorporated within a luggage tag 300, as shown in FIG. 3,. The luggage tag 300 includes a housing 305 and an attachment mechanism 320 to facilitate connection to a luggage. Coupled to the housing 305 is an indicating light, such as LED 325 and a display screen 315, and a speaker 340 (coupled to a sound generator) for providing an audible indication. Further coupled to the housing 305 are manually actuated switches 330, 335 to enable a user to manually operate the luggage tag 300 on and off and to program it to recognize digital codes emitted by a remote transmitter unit. The luggage tag 300 may also include a label holder 310 to place a hand written label indicating the identity of the owner of the luggage. In one embodiment, the electrically powered components within the luggage tag is normally turned off and are activated by electromagnetic energy detection (EED) circuit in response to detection of at least one defined range of signal frequency.

While the foregoing embodiments of the invention have been described and shown, it is understood that variations and modifications, such as those suggested and others within the spirit and scope of the invention, may occur to those skilled in the art to which the invention pertains. The scope of the present invention accordingly is to be defined as set forth in the appended claims.

What is claimed is:

1. An apparatus comprising:
a power source;
a receiver to receive wireless signals; and
a power controller coupled to the receiver and the power source to prevent power from being supplied to the receiver in a first mode and enable power to be supplied to the receiver in a second mode, wherein the power controller automatically switches from the first mode to the second mode in response to reception of at least one range of frequency of signal.

2. The apparatus of claim 1, wherein the power controller includes electromagnetic energy detection (EED) circuit which is responsive to electromagnetic energy transmitted by a remote transmitter unit.

3. The apparatus of claim 2, wherein the EED circuit is a passive circuit that does not require power supplied from the power source.

4. The apparatus of claim 1, further comprising:
a processor coupled to the receiver, the signal processor to recognize at least one defined signal code transmitted by a remote transmitter unit; and
an indicator coupled to the processor to provide an indication of receiving of the defined signal code.

5. The apparatus of claim 4, wherein the processor is capable of learning to recognize at least one coded signal transmitted by a remote transmitter.

6. The apparatus of claim 5, wherein the receiver, the power controller, the processor and the indicator are contained within an identification tag.

7. The apparatus of claim 6, wherein the identification tag is a luggage tag.

8. The apparatus of claim 1, wherein the power controller includes circuitry capable of absorbing electromagnetic radiation energy and converting the energy into an electrical current.

9. The apparatus of claim 1, wherein the power controller includes circuitry tuned to respond to at least one range of frequency of signals.

10. The apparatus of claim 1, further comprising:
a housing having an attachment mechanism to facilitate connection to an object.

11. A system comprising:
a remote transmitter unit to transmit wireless signal code; and
a receiver unit to receive the signals transmitted by the transmitter unit and to indicate reception of the signal code from the remote transmitter unit, wherein the receiver unit capable of automatically switching from a first mode in which the receiver unit remains powered off to a second mode in which the receiver unit is powered on in response to reception of an electromagnetic signal.

12. The system of claim 11, wherein the receive unit includes electromagnetic energy detection (EED) circuit which is responsive to electromagnetic energy transmitted by the remote transmitter unit.

13. The system of claim 12, wherein the EED circuit is a passive circuit that does not require power supplied from the power source.

14. The system of claim 11, wherein the receiver unit comprises:
a power source;
a receiver to receive wireless signals;
a power controller coupled to the receiver and the power source to automatically switch from the first mode to the second mode in response to reception of at least one range of frequency of signal;
a processor coupled to the receiver to recognize at least one defined signal code transmitted by the remote transmitter unit; and
an indicator coupled to the processor to provide an indication of receiving of the defined signal code.

15. The system of claim 11, wherein the receiver unit is contained an identification tag.

16. The system of claim 15, wherein the identification tag is a luggage tag.

17. The system of claim 14, wherein the power controller includes circuitry capable of absorbing electromagnetic radiation energy and converting the energy into an electrical current.

18. The system of claim 14, wherein the power controller includes circuitry tuned to respond to at least one range of frequency of signals.

19. The system of claim 11, wherein the remote transmitter unit is capable of operating at least one remote control functions of a vehicle.

20. The system of claim 19, wherein the receiver unit is capable of learning to recognize at least one coded signal transmitted by the remote transmitter unit.

21. A method comprising:
preventing power from being supplied to a wireless receiver component in a first mode;
enabling power to be supplied to the receiver component in a second mode; and
automatically switching from the first mode to the second mode in response to reception of at least one range of signal frequency.

22. The method of claim 21, further comprising:
converting at least one range of frequency of signal into an electrical current; and
using the electrical current to turn on a switch to enable power to be supplied to the receiver component.

23. The method of claim 21, further comprising:
determining if a received signal is a valid activation signal; and
providing an indication upon detection of the valid activation signal.

24. The method of claim 21, further comprising:
learning to recognize at least one defined signal code transmitted by a remote transmitter capable of operating at least one remote control function of a vehicle.

25. The method of claim 21, further comprising:
turning off power supplied to at least the wireless receiver component if the at least one range of signal frequency has not been detected within a predetermined time period.

26. A luggage tag comprising:
a power source;
a receiver to receive wireless signals;
a processor coupled to the receiver, the signal processor to recognize at least one defined signal code transmitted by a remote transmitter unit;
a user alerting element coupled to the processor to provide an indication of receiving of the defined signal code; and
a housing having an attachment mechanism to removably connect to a luggage.

27. The luggage tag of claim 26, wherein the user alerting element comprises at least one of a visual device and an audio producing device.

28. The luggage tag of claim 26, wherein the processor is capable of learning to recognize at least one coded signal transmitted by a remote transmitter unit.

29. The luggage tag of claim 28, wherein the remote transmitter unit is capable of operating at least one remote control function of a vehicle.

30. The luggage tag of claim 26, further comprising:
electromagnetic energy detection (EED) circuit which is used to automatically enable power to be supplied to the receiver in response to reception of at least one range of frequency of signal, wherein the EED circuit is a passive circuit that does not require power supplied from the power source.
